(19) United States
(12) Patent Application Publication
(10) Pub. No.: US 2023/0382253 A1
(43) Pub. Date: Nov. 30, 2023

(54) Charging device having emergency power supply, and method for the supply of emergency power

(71) Applicant: Webasto SE, Stockdorf (DE)

(72) Inventor: Andreas Maier, Stockdorf (DE)

(21) Appl. No.: 18/032,676

(22) PCT Filed: Oct. 20, 2021
(86) PCT No.: PCT/EP2021/079073

§ 371 Date: Apr. 19, 2023

(30) Foreign Application Priority Data
Oct. 20, 2020 (DE) 102020127628.1

(51) Int. Cl. B60L 53/35; B60L 53/16; B60L 53/55

(52) U.S. Cl. CPC B60L 53/35; B60L 53/16; B60L 53/55

(57) ABSTRACT

The present invention relates to a charging device for charging a vehicular unit of an electric vehicle, comprising a power supply means for providing an electric charging current and comprising a ground unit having a power delivery means, where the power delivery means is arranged on a movable arm that is movable between an initial position, in which the movable arm is located in the ground unit, and a coupling position, in which the power delivery means is electrically connected to the vehicular unit, where provided in the ground unit there is an emergency power supply means that is designed and configured to provide sufficient electrical energy to return the movable arm to its initial position in the event of a power failure.

### CROSS-REFERENCE TO RELATED APPLICATIONS

This application is a 35 U.S.C. § 371 National Stage Entry of International Application No. PCT/EP2021/079073 filed Oct. 20, 2021, which claims the priority benefit of German Patent Application Serial Number DE 10 2020 127 628.1 filed Oct. 20, 2020, all of which are incorporated herein by reference in their entirety for all purposes.

### TECHNICAL FIELD

The present invention relates to a charging device for charging a vehicular unit of an electric vehicle. The present invention further relates to a method for an automated return of a movable arm of a charging device for charging a vehicular unit of an electric vehicle.

### BACKGROUND

Electric vehicles, or plug-in hybrid vehicles, have a traction battery that must be charged at regular intervals. The respective ranges of the electric vehicles and the respective distances driven determine the requirement for more frequent or less frequent charging of the electric vehicle.

In the majority of electric vehicles known from prior art, battery charging is realized by a conductive charging process via a charging cable. Cable-connected charging has the advantage that, with an appropriately designed cable, charging can be performed virtually without loss and with a high charging power. Furthermore, cable-connected charging of an electric vehicle is associated with relatively low infrastructure costs due to the relatively inexpensive production of cables and plugs, or connection elements. Often, cable-connected charging is accomplished in that the electric vehicle is parked at a charging post or a wallbox, and the user then establishes a connection between the charging post or wallbox and the electric vehicle by manually plugging-in a corresponding charging plug. The actual charging process can then be started.

At present, the ranges achievable on one battery charge are often still below the ranges that can be achieved on one tank of fuel for a conventional internal combustion engine vehicle, such that, for the user, the resulting need for more frequent charging may be regarded as a detriment to convenience.

Various devices for the automated connection of electric vehicles to charging devices are known for the purpose of automating the process of connecting the electric vehicle, and thus saving time and effort on the part of the user and thereby enhancing convenience.

For the automated connection of electric vehicles to charging devices, there are known robotic arms, having attached plugs, that enable automated positioning of the plug in a charging socket of an electric vehicle and thus start the charging process in an automated manner. In this regard, charging facilities that are integrated into a ground unit are particularly user-friendly.

In practice, however, it has been shown that, in the case of charging devices that are integrated into the ground unit, unforeseen system failures may result in unfavorable situations. Since the charging device is located underneath the vehicle, between the vehicle floor and the parking area, and is therefore difficult to access, manual intervention by the user in an emergency situation is not readily possible.

### PRESENTATION OF THE INVENTION

It is therefore an object of the invention to provide a charging device, for charging a vehicular unit of an electric vehicle, that enables reliable operation.

The object is achieved by a charging device, for charging a vehicular unit of an electric vehicle, having the features of claim 1. Advantageous developments follow from the dependent claims, the following representations and the description of a preferred exemplary embodiment.

There is accordingly proposed a charging device for charging a vehicular unit of an electric vehicle, comprising a power supply means for providing an electric charging current and comprising a ground unit having a power delivery means, wherein the power delivery means is arranged on a movable arm that is movable between an initial position, in which the movable arm is located in the ground unit, and a coupling position, in which the power delivery means is electrically connected to the vehicular unit. According to the invention, provided in the ground unit there is an emergency power supply means that is designed and configured to provide sufficient electrical energy to return the movable arm to its initial position in the event of a power failure.

For the purposes of the present disclosure, the charging device may comprise all electrical and mechanical components necessary for actuating the charging device. For the purposes of the present disclosure, a power supply means may be understood as an electrical power outlet. Equally, a power supply means may be understood as a control cabinet, for example in the form of a wallbox. The power supply means is connected to an external energy source and may optionally comprise a rectifier. The power supply means may in particular be a power supply unit that draws an alternating current from an external energy source and provides a conditioned direct current for the charging device.

The ground unit may, for example, be fully or partially embedded in the ground of a roadway or parking area, and the movable arm of the ground unit may be moved out of the ground unit within a designated radius of movement.

Alternatively, the ground unit may be arranged on the roadway or parking area in a fixed or travelling manner.

In this case, the “vehicular unit, arranged above” of the electric vehicle is to be understood as a vehicular unit arranged in an electric vehicle that is positioned, in particular parked, over the ground unit. The wording “movable between an initial position and a coupling position” is not intended to restrict the present disclosure to the effect that the movable arm is only movable between these two positions. Rather, the movable arm may be moved to any number of other positions.

For the purposes of the present disclosure, a power delivery means may be understood as a means via which an electrical connection may be established between the ground unit and the vehicular unit. Accordingly, for the purposes of the present disclosure, a vehicular unit may mean a component of the electric vehicle that is suitable for being electrically connected to the complementary power delivery means of the ground unit.

For the purposes of the present disclosure, an emergency power supply means may in the broadest sense be understood as a means that provides an energy reservoir that is sufficient to move the movable arm back to its initial position when a power failure occurs. In principle, in this case the position of the movable arm at the time of the power failure is immaterial. For the purposes of the present disclosure, a power failure may mean any state in which no power is applied to the ground unit and, accordingly, the mechanical function of the movable arm is interrupted.

If, for example, the movable arm is currently in the coupling position, for instance because an active charging process is currently in progress, and a power failure suddenly occurs, according to the prior art the movable arm would have to be manually decoupled and moved to its initial position in order to then release the vehicle and enable it to be moved away.

The returning of the movable arm to its initial position in the ground unit in the event of a power failure ensures that the movable arm does not protrude from the ground unit or, in the worst case, is still coupled to the vehicular unit. Thus, on the other hand, it is thereby possible to avoid a situation in which a user has to move the movable arm manually in the event of a power failure in order to decouple the electric vehicle from the charging device. On the other hand, it is thereby possible to avoid a situation in which, in the event of a power failure, the movable arm protrudes from the ground unit and is accidentally driven over when the electric vehicle is moved from the charging position. In summary, it can thus be achieved that in the event of a power failure, the user of the charging device does not have to take any action to avoid potential damage.

Since the emergency power supply means is provided in the ground unit, easy connection to an existing charging device becomes possible. In other words, the ground unit equipped with the emergency power supply means can be easily coupled to an already existing charging device without the need to modify the charging device. Accordingly, the charging device does not need to provide emergency power supply means, as this is already provided in the ground unit. In other words, the ground unit is autonomous in respect of the mechanical design and its control, even in the event of a power failure.

Furthermore, the ground unit is also autonomous, and can move the movable arm back to its initial position and thus mechanically release the vehicle again if the charging device, for example in the form of a wallbox, has been switched off by the tripping of a safety circuit or if a residual-current circuit-breaker upstream of the wallbox has tripped. In other words, the provision of the emergency power supply means makes it possible for the movable arm to be moved back autonomously by the ground unit to the initial position.

Further, an emergency power supply means can be easily retrofitted in an existing system. Furthermore, the emergency power supply means can be arranged as close as possible to mechanical actuators of the movable arm. Thus, even in the event of major damage to the charging device, for instance caused by fire damage to a wallbox or adjoining wiring, it is still possible for electrical energy to be provided to the ground unit via the emergency power supply means.

According to an advantageous development, furthermore a control device is provided, which is designed and configured to move the movable arm between the initial position and the coupling position. The control device and the energy supply for the movable arm may be located in the ground unit. The control device is then preferably also supplied with emergency power.

Since the control device is provided in the power supply means, it becomes possible for the ground unit to be realized as a self-contained unit. In this case, the ground unit may be functionally limited to moving the movable arm and to providing the emergency power supply means for returning the movable arm in the event of a power failure. A simple and robust design of the ground unit thus becomes possible. Further, this enables the ground unit itself to be less susceptible to electrical failure, thereby increasing operational safety.

According to an advantageous development, the power delivery means comprises a charging plug that is designed and configured to engage in a charging socket of the vehicular unit and to provide a conductive connection between the charging plug and the charging socket. The charging plug in this case may preferably be arranged at a free end of the movable arm.

Since the power delivery means has a charging plug that is designed and configured to engage in a charging socket of the vehicular unit, a definite and secure positioning of the power delivery means relative to the vehicular unit can be achieved. Since the charging plug is designed and configured to provide a conductive connection between the charging plug and the charging socket, a low-loss transmission of electrical energy from the power delivery means to the vehicular unit can be achieved. Consequently, an efficient charging process can thus be achieved.

Furthermore, it is advantageous for the emergency power supply means to have capacitors and/or capacitances. The advantage of using capacitors is their ability to rapidly store and deliver large amounts of electrical charge. Capacitors also have the advantage of being continuously charged and discharged without this resulting in degradation of the component, such as is the case with batteries. Moreover, this allows the charging device to be designed for a very large temperature range, for instance a temperature range of from −40° C. to 85° C.

Advantageously, the emergency power supply means is designed and configured in such a way that brief peak currents of the charging device can also be effected from the capacitors. Consequently, the emergency power supply means can be dimensioned for a lower output power, thereby enabling cost savings to be possible.

Advantageously, the emergency power supply means has a supercapacitor. For the purposes of the present disclosure, a supercapacitor, also called a “supercap”, may be understood as a series connection of capacitors. The interconnection of the supercapacitors may also be a combination of a series connection and a parallel connection, depending on the dimensioning and in dependence on the energy required. For example, a second string of series capacitors may be arranged in parallel with the series capacitors of the first string.

The use of a supercapacitor has the advantage that supercapacitors are suitable as energy stores in particular when wide temperature ranges, a long service life, high currents, high cycle stability and/or rapid charging are required. Furthermore, supercapacitors do not require much installation space. If the supercapacitor is used as a back-up power supply during high power demands, it can help reduce the size of the supply units, provide higher power output and improve overall performance. Present-day supercapacitors have a high energy density and power density.

Furthermore, the emergency power supply means has a charging path and a discharging path. This enables the emergency power supply means to be charged and discharged selectively. For this purpose, the emergency power supply means may be connected to a corresponding switching signal. For example, the charging path may be designed and configured such that, when an electric current is provided via the power supply means, the emergency power supply means is charged. Nevertheless, the discharge path may be designed and configured such that the emergency power supply means is only discharged when a corresponding signal is sent to the emergency power supply means.

In an alternative, there is no selective charging and/or discharging, and the charging process takes place as soon as a voltage is applied by the power supply device. The discharging process begins accordingly, as soon as no more voltage is being provided—for example, even in the event of a power failure.

According to an advantageous development, there is a diode controller, in particular an LM74610 controller, provided in the charging path and/or discharging path. The advantage of using an LM74610 controller is that it can be used with an n-channel MOSFET in a reverse polarity protection circuit. Thus, an external MOSFET can be driven in order to emulate an ideal diode rectifier when connected in series to a power source.

It is also advantageous if the LM74610 controller, together with the emergency power supply means, is configured so that there is no current limiting. The current limiting during charging may be realized via the energy supply (via constant current limiting).

Optionally, a further e-fuse may also be placed in the charging path in order to interrupt the connection of the capacitors to the supply voltage in the event of a short-circuit.

A further advantage of the LM74610 controller is that it is not referenced to ground and thus has zero Iq. The LM74610 controller can be used to provide a gate driver for an external n-channel MOSFET. The LM74610 controller also has a fast-response internal comparator to discharge the MOSFET gate when the polarity is reversed. This fast pull-down function limits the amount and duration of the reverse current flow when the opposite polarity is measured. Moreover, the device design of the LM74610 controller complies with CISPR25 Class 5 EMI specifications and automotive-sector ISO7637 transient requirements with a suitable TVS diode.

According to an advantageous development, there a circuit protection means, in particular a TPS25982 controller, provided in the discharging path. This makes it possible to monitor a load current in the discharging path and to achieve adjustable, transient fault management in the discharging path. More specifically, a circuit protection means may be used to achieve robust protection against overload, short-circuits, overvoltages and excessive inrush current.

The advantage of using a TPS25982 controller is that overvoltage events can basically be limited by internal interrupt circuits with several component options for selecting the overvoltage threshold. It is thus possible to achieve robust protection against overload, short-circuits, overvoltages and excessive inrush current. It is also advantageous in this case that a single external resistor can be used to set the overcurrent limit and the fast-trip (short-circuit) threshold.

Alternatively, an overvoltage protection is not used in the discharging path, in particular in cases in which, on the one hand, the adjustable threshold values are significantly higher than 12 V and, on the other hand, the supercapacitors will not deliver any overvoltage. Optionally, an overvoltage protection may be provided in the charging path, as the capacitors can react very sensitively to overvoltage. This can be advantageous, in particular, if further voltage sources can be connected externally by the user.

According to an advantageous development, the power supply means provides a direct current at a voltage of 12 V, wherein the emergency power supply means is designed and configured in such a way that, in the case of a charging current equal to 10 A, the charging time of the emergency power supply means is approximately 12 s. This enables the emergency power supply means to be charged within a short period of time. In particular, the charging of the emergency power supply means can be completed before the movable arm has been moved. Thus, the subsequently moved movable arm can be returned to its initial position at any time by means of the emergency power supply means.

According to an advantageous development, there is an open-drain output signal line between the power supply means and the power delivery means. This allows a signal that remains a logical zero to be provided in the event of a power failure, thereby allowing the power failure to be communicated to one or more connected logic elements. In particular, this can cause the emergency power supply means to provide electrical energy to return the movable arm to its initial position.

In an alternative embodiment, the electrical energy may always be provided, i.e. independently of a control signal. This eliminates the need for selective charging and discharging, and the charging process takes place as soon as a voltage is applied by the power supply device. The discharging process begins accordingly, as soon as no more voltage is being provided—for example, even in the event of a power failure.

The object is further achieved by a method for supplying a charging device for charging a vehicular unit of an electric vehicle, having the features of claim 11. Advantageous developments are apparent from the dependent claim, the following representations and the description of a preferred exemplary embodiment.

Accordingly, a method is proposed for the automated return a movable arm of a charging device for charging a vehicular unit of an electric vehicle, comprising the step of providing sufficient electrical energy to a ground unit to move a movable arm to an initial position by means of an emergency power supply means arranged in the ground unit.

As a result, in the event of a power failure, a return of the movable arm can be achieved solely by means of the components of the ground unit. This has the advantage that, even if components of the charging device arranged outside of the ground unit are affected by the power failure or are otherwise damaged, a return of the movable arm can be achieved. Thus, the overall operational safety of the charging device can be improved.

According to an advantageous development, the method further comprises a step of outputting an open-drain output signal comprising an item of information, from a power delivery means, indicating that there is a power failure. As a result, a signal can be provided, by means of which further components associated with the charging device can be selectively switched in such a way that an automated return of the movable arm into the ground unit can be achieved.

### BRIEF DESCRIPTION OF THE FIGURES

Preferred further embodiments of the invention are explained in more detail by the following description of the figures. In the figures:

FIG. 1 shows, in schematic form, a charging device for charging a vehicular unit of an electric vehicle; and

FIG. 2 shows an example of a circuit diagram for connection of the charging device from FIG. 1.

### DETAILED DESCRIPTION OF PREFERRED EXEMPLARY EMBODIMENTS

In the following, preferred exemplary embodiments are described on the basis of the figures. In the different figures, elements that are the same or similar or that have the same effect are denoted by identical references, and repeated description of these elements is partially omitted in order to avoid redundancies.

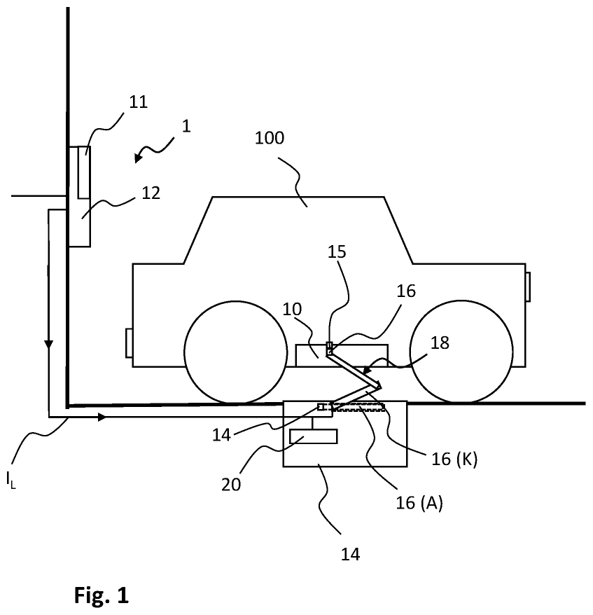

Shown schematically in FIG. 1 is a charging device 1 for charging a vehicular unit 10 of an electric vehicle 100. The charging device 1 in this case comprises a power supply means 12 for providing an electric current I_{L}, and a ground unit 14 having a power delivery means 16.

The power delivery means 16 in this case is arranged on a movable arm 18. The movable arm 18 can be moved between an initial position A and a coupling position K. The initial position A in this case is a position in which the movable arm 18 is located in the ground unit 14. In the illustration in FIG. 1, the initial position A is represented by a dashed line. In the illustration in FIG. 1, the movable arm 18 is represented in the coupling position K, which corresponds to a position in which the power delivery means 16 is electrically connected to the vehicular unit 10.

Furthermore, provided in the ground unit 14 there is an emergency power supply means 20 that is designed and configured to provide sufficient electrical energy to return the movable arm 19 to its initial position A in the event of a power failure.

The charging device 1 according to FIG. 1 is also designed and suitable for positioning the movable arm 18 of the ground unit 14 in, or on, the vehicular unit 10 in an automated manner. Specifically, this is effected via a power delivery means 16 in the form of a charging plug, which is arranged at a free end of the movable arm 18 and which can be positioned automatically in a charging socket 15 that is arranged on the vehicular unit 10. The power delivery means 16, which is in the form of a charging plug, is designed and configured to engage in the charging socket 15 of the vehicular unit 10, thereby providing a conductive connection between the charging plug and the charging socket 15. This allows an electrical connection to be established between the charging plug 19 and the charging socket 15.

The charging device 1 further comprises a control device 11 that is designed and configured to move the movable arm 18 between the initial position A and the coupling position K. In this case, the control device 11 of the charging device 1 is arranged in the power supply means 12.

Alternatively, the control device 11 of the charging device 1 may also be arranged in the ground unit 14. In any case, the control device 11 must be supplied with power, preferably 12V, in the event of a power failure in order to enable the method of moving the movable arm 18 into a safe position.

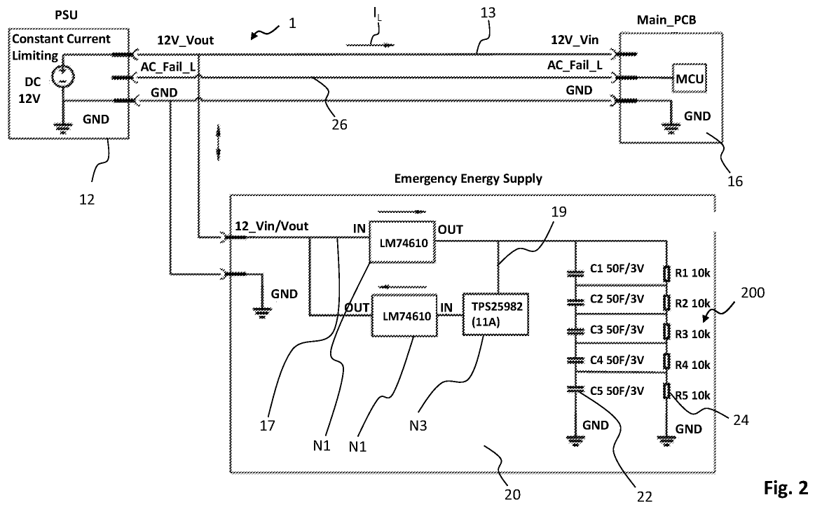

FIG. 2 shows an example of a circuit diagram for connection of the charging device 1 from FIG. 1. According to this circuit diagram, for the purpose of supplying a charging current I_{L} to a vehicular unit of an electric vehicle, the charging device 1 comprises a power supply means 12 and a power delivery means 16. The power delivery means 16, also referred to as the main PCB, is the control unit of the arm motor system and at the same time provides the power supply for the motors. Both may be supplied with emergency power, in particular 12 V emergency power, by capacitors. Also provided in the charging device 1 is an emergency power supply means 20, which is designed and configured to return the movable arm (not shown in FIG. 2) to its initial position in the event of an interruption in the charging current.

For this purpose, the emergency power supply means 20 has capacitors 22 and resistors 24. In the embodiment shown, the emergency power supply means 20 has a series circuit of five capacitors 22 and five resistors 24. By means of this arrangement, a supercapacitor 200 is realized. Nevertheless, the capacitors 22 may themselves be supercapacitors or be structured as supercapacitors. By means of the resistors 24 between the individual capacitors 22, a so-called balancing can be achieved, enabling a uniform charging of the capacitors 22.

As part of the emergency power supply means 20, the supercapacitor 200 is connected to a main power line 13 of the charging device 1 via an electrical connection. More precisely, this connection of the emergency power supply means 20 has a charging path 17 and a discharging path 19. In this case, in both the charging path 17 and the discharging path 19 there is a diode controller N1, each of which is in the form of an LM74610 controller. Further, a circuit protection means N3, in the form of a TPS25982 controller, is provided in the discharging path 19.

The power supply means 12 provides a direct current having a voltage of 12 V, the emergency power supply means 20 being designed and configured in such a way that, in the case of a charging current equal to 10 A, the charging time of the emergency power supply means 20 is approximately 12 s. Between the power supply means 12 and the power delivery means 16 there is an open-drain output signal line 26, via which, in the event of a power failure, a signal can be provided that remains a logical zero, thereby allowing the power failure to be communicated to the emergency power supply means and causing the latter to return the movable arm to its initial position A.

Insofar as applicable, any of the individual features represented in the exemplary embodiments may be combined with one another and/or interchanged without departure from the scope of the invention.

### LIST OF REFERENCES

A initial position
I_{L} electric current
K coupling position
N1 diode controller
N3 circuit protection means
1 charging device
10 vehicular unit
11 control device
12 power supply unit
13 main power line
14 ground unit
15 charging socket
16 power delivery means
17 charging path
18 movable arm
19 discharging path
20 emergency power supply means
22 capacitor
24 resistor
26 open-drain output signal line
100 electric vehicle
200 supercapacitor

1. A charging device for charging a vehicular unit of an electric vehicle, comprising: a power supply means for providing an electric charging current and comprising a ground unit having a power delivery means, wherein the power delivery means is arranged on a movable arm (18) that is movable between an initial position, in which the movable arm is located in the ground unit, and a coupling position, in which the power delivery means is electrically connected to the vehicular unit,
wherein an emergency power supply means is provided in the ground unit that is designed and configured to provide sufficient electrical energy to return the movable arm to its initial position in the event of a power failure.

2. The charging device as claimed in claim 1, wherein a control device is provided, which is designed and configured to move the movable arm between the initial position and the coupling position.

3. The charging device as claimed in claim 2, wherein the power delivery means comprises a charging plug that is designed and configured to engage in a charging socket of the vehicular unit and to provide a conductive connection between the charging plug and the charging socket.

4. The charging device as claimed in claim 3, wherein the emergency power supply means has capacitors and resistors.

5. The charging device as claimed in claim 4, wherein the emergency power supply means has a supercapacitor.

6. The charging device as claimed in claim 5, wherein the emergency power supply means and a discharging path.

7. The charging device as claimed in claim 6, wherein there is a diode controller provided in at least one of: the charging path and the discharging path.

8. The charging device as claimed in claim 7, wherein there a circuit protection means provided in the discharging path.

9. The charging device as claimed in claim 8, wherein the power supply means provides direct current at a voltage of 12 V, wherein the emergency power supply means is designed and configured in such a way that, in the case of a charging current equal to 10 A, the charging time of the emergency power supply means is approximately 12 s.

10. The charging device as claimed in claim 9, wherein there is an open-drain output signal line between the power supply means and the power delivery means.

11. A method for the automated return a movable arm of a charging device for charging a vehicular unit of an electric vehicle in the event of a power failure, comprising the step of:
providing sufficient electrical energy to a ground unit to move a movable arm to an initial position by means of an emergency power supply means arranged on the ground unit.

12. The method as claimed in claim 11, further comprising a step of:
outputting an open-drain output signal comprising an item of information, from a power delivery means, indicating that there is a power failure.

13. The charging device as claimed in claim 7, wherein the diode controller is an LM74610 controller.

14. The charging device as claimed in claim 8, wherein the circuit protection means is a TPS25982 controller.
